(19) United States
(12) Patent Application Publication
(10) Pub. No.: US 2026/0357913 A1
(43) Pub. Date: Nov. 12, 2026

(54) Pressure Equalization Element, and Method for Installing Said Pressure Equalization Element

(71) Applicant: Bayerische Motoren Werke Aktiengesellschaft, Muenchen (DE)

(72) Inventors: Maximilian Tristan Philipp ROSENBERGER, Muenchen (DE); Thomas SPIESS, Muenchen (DE)

(21) Appl. No.: 19/136,012

(22) PCT Filed: Dec. 21, 2023
(86) PCT No.: PCT/EP2023/087207

§ 371 Date: Jun. 5, 2025

(30) Foreign Application Priority Data
Jan. 11, 2023 (DE) 10 2023 100 454.9

(51) Int. Cl. F16K 17/18

(52) U.S. Cl. CPC F16K 17/18

(57) ABSTRACT

A pressure equalization element for adhesively bonding to a surface provided with a pressure equalization opening, wherein the pressure equalization element has a first film with a first surface for adhesively bonding to a surface of a housing, a second film which, on a second surface lying opposite the first surface, is connected to the latter, and a membrane film arranged geometrically between the first film and the second film on the second surface. The first film has a pressure equalization cut-out covered by said membrane film. Before installation on the surface of the housing, the pressure equalization element is received with the first surface of the first film on a carrier film. The carrier film can be removed from said first surface for installation. The carrier film has at least one test cut-out. The test cut-out and the pressure equalization cut-out overlap.

### BACKGROUND AND SUMMARY

This disclosure relates to a pressure equalization element and a method for installing such a pressure equalization element. From DE 102014 105 193 A1, a pressure equalization label for adhesive bonding to a surface and a method for manufacturing such a pressure equalization element are known.

The following describes the use of a pressure equalization element on a motor vehicle drive unit; however, this should not be construed as limiting the disclosure to such an application. During manufacturing, pressure equalization elements having a membrane, wherein the membrane is at least air-permeable in one direction and moisture-impermeable, are applied to a carrier film. This carrier film with the pressure equalization elements is wound into a film roll. The film roll is inserted into a dispensing machine in the production equipment. This dispensing machine separates the pressure equalization elements and deposits them in such a way that a manipulator can pick up individual pressure equalization elements and then apply them to an interface on a drive unit provided for pressure equalization.

Furthermore, subsequently, i.e., after application of the pressure equalization element to this interface, a flow test device is applied to the pressure equalization element, and a vacuum is applied to the pressure equalization element using this device. This vacuum generates an air flow through the pressure equalization element, which can be measured and compared to a target value. When applying the pressure equalization element to the interface on the drive unit, it may be elastically deformed, and it may take a considerable amount of time for the pressure equalization element or parts thereof to return to their original state after this elastic deformation. However, this elastic deformation leads to a change in the possible air flow through the pressure equalization element. In other words, a pressure equalization element shows different flow values immediately after being applied to the interface than it does after a certain period of time has elapsed. Against this background, it is known to either establish a correlation between a measurement taken immediately after application and one taken after a delay, or to perform a measurement of the air flow only after a delay. In the first alternative (measurement immediately after application of the pressure equalization element), the air flow measured does not correspond to that during normal operation. In the second alternative (measurement of the air flow after a delay), it is necessary to wait a certain amount of time after the pressure equalization element is applied before carrying out the air flow measurement, which results in a dead time in the production process.

Within the meaning of the disclosure, a pressure equalization element is understood to be a device that enables pressure equalization between an interior space and the environment adjacent to said interior space by way of an air flow, wherein this air flow passes through the pressure equalization element, and wherein uncontrolled ingress of foreign substances, especially moisture and particles, is prevented or at least hindered by the pressure equalization element. Such pressure equalization elements are known in various designs, particularly from drive devices such as a gearbox, and are then referred to as so-called gearbox breathers. The present disclosure concerns a pressure equalization element for adhesive bonding to a surface of a housing or another object that is provided with a pressure equalization opening. Such a pressure equalization element is also referred to as a pressure equalization label, as it can be adhered to a surface in a manner similar to a label. In its installed or bonded state, the pressure equalization element covers an opening in a housing, so that an air flow from or into this housing passes through the pressure equalization element. In general, it is possible to provide a pressure equalization system with several such pressure equalization elements, so that, for example, only the incoming or only the outgoing or only a partial air flow passes through such a pressure equalization element, or only a single such pressure equalization element is provided, in which case both the incoming and outgoing air flows pass through the same pressure equalization element.

The proposed pressure equalization element is composed of several layers, with one such layer being able to include a film or consist of a film. The term “film” in this sense—as well as in general—is understood to mean a thin-layer component. Pressure equalization elements comprising films are in principle known from the prior art, in particular from the aforementioned DE 102014 105 193 A1.

The proposed pressure equalization element comprises, as one of its components, a first film, which is configured with a first surface for adhesive bonding to a surface, in particular a component surface, of a housing. The pressure equalization element can therefore be adhered directly to this component surface using the first surface of the first film. Preferably, this first surface has an adhesive or adhesion layer, which is configured to form a materially bonded connection with the component surface during installation of the pressure equalization element.

Furthermore, the pressure equalization element comprises, as one of its components, a second film, which is connected, at least in sections and preferably in a materially bonded manner, to the second surface of the first film, which lies opposite the first surface. Figuratively speaking, the first and second films are connected to each other in a planar geometric manner. Additionally, the first and second films are geometrically different in design and not fully bonded to one another, thereby forming at least one ventilation channel between these two films. During normal operation of the pressure equalization element, this ventilation channel allows for the venting or intake air flow, referred to as pressure equalization air flow.

The pressure equalization element also comprises a membrane film, which is arranged geometrically between the first and second film and thus also on the second surface of the first film. Preferably, the second film is arranged at a distance from this membrane film so that an air flow can pass through this membrane film. The membrane film is functionally designed so that a pressure equalization flow passes through it, enabling pressure equalization during the intended operation of the pressure equalization element. Furthermore, the first film comprises a pressure equalization cut-out, in particular to allow for this pressure equalization flow, and this membrane film covers the pressure equalization cut-out. In particular, it is the first film that positions the membrane film during the intended operation of the pressure equalization element. The disclosure relates to an embodiment of the pressure equalization element before its installation for regular operation, wherein the pressure equalization element in this pre-installation state is mounted on a carrier film on the surface of the housing, with the first surface of the first film, and wherein the carrier film is removable from this first surface for installation and is removed from this first surface during installation. Furthermore, the carrier film comprises a test cut-out, and this test cut-out in the carrier film is arranged such that the test cut-out in the carrier film and the pressure equalization cut-out in the first film at least partially overlap and preferably completely overlap. In particular, in such an embodiment of the disclosure, a test air flow can be guided through the membrane film before its planned installation, as the membrane film is not fully covered by the carrier film. This enables a functional test of the pressure equalization element before its regular installation and thus prevents—or at least reduces the probability of—installing a non-functional pressure equalization element. In contrast to conventional pressure equalization elements, where functional testing is only possible after installation and where, if the pressure equalization element is not functional, there is a risk of installing a defective unit, the pressure equalization element according to the disclosure enables functional testing immediately before installation, thereby reducing any potentially necessary rework.

In a preferred embodiment of the pressure equalization element, the carrier film comprises a plurality of test cut-outs, with these test cut-outs—or at least two of them—being separated from one another by carrier film webs or a plurality of carrier film webs. The test cut-outs may have any geometric shape, and the carrier film webs are formed by the material areas of the carrier film located between these test cut-outs. Furthermore, it is proposed that at least one or a plurality of these test cut-outs at least partially or fully overlap the pressure equalization cut-out in the first film. This overlap in particular results in a fluid-conducting connection through the carrier film to the membrane film, thus enabling a functional test of the pressure equalization element while the carrier film is still attached—i.e., prior to the regular installation of the pressure equalization element. It is further proposed that at least one of these carrier film webs at least partially covers this test cut-out in the first film. In particular, this kind of partial coverage of the membrane film by such a carrier film web results in mechanical protection for the membrane film. This protection allows the pressure equalization element, attached to the carrier film, to be safely transported and handled.

In a preferred embodiment of the disclosure, the carrier film comprises at least one test cut-out, and the at least one test cut-out and the pressure equalization cut-out are arranged congruently with respect to each other. Preferably, the pressure equalization cut-out in the first film lies entirely within the test cut-out in the carrier film, such that an unobstructed flow through the pressure equalization cut-out via the test cut-out to the membrane film is possible. In particular, within the meaning of the disclosure, such an arrangement where the pressure equalization cut-out lies entirely within the test cut-out is also to be understood as congruent in this context. Especially with such congruent alignment, a straightforward test of the membrane film's flow permeability is enabled.

A method is also proposed for installing a pressure equalization element in one of the above-described embodiments. This method comprises at least the following steps:
placing the pressure equalization element with carrier film into a test device;
applying a pressure differential between the side of the pressure equalization element on which the carrier film is located and the opposite side of the pressure equalization element, so that this pressure differential results in a test air flow through the pressure equalization element;
evaluating the pressure equalization element based on the test air flow;
removing the carrier film from the first surface of the first film; and,
installing the pressure equalization element on the surface of the housing.

Such a method enables the pressure equalization element in question to be tested prior to its installation, thereby reducing the probability of installing a pressure equalization element that is not or not fully functional. Preferably, the test device includes a vacuum or pressure bell that is placed onto the pressure equalization element in order to generate this pressure differential and thereby produce the test air flow.

In a preferred embodiment of the installation method for a pressure equalization element of the described type, the evaluation of the pressure equalization element—specifically, whether it is suitable for installation (iO status) or not (niO status)—is based on direct or indirect detection of the test air flow. In this context, detection particularly means measuring the test air flow or, preferably, the pressure differential. Furthermore, the detected test air flow or its measured value is compared with a target test air flow. Such a target test air flow may, in particular, be a theoretical or experimentally determined target value or range, by way of which the functionality of the tested pressure equalization element can be evaluated.

The following describes individual features and embodiments of the disclosure in greater detail with reference to at least partially schematic illustrations, noting that other combinations of features than those shown are also possible.

### BRIEF DESCRIPTION OF THE DRAWINGS

FIG. 1 shows a sectional view of a pressure equalization element for adhesive mounting onto a surface with a pressure equalization opening on a carrier film; and,

FIG. 2 shows a top view of a carrier film with multiple test cut-outs.

### DETAILED DESCRIPTION OF THE DRAWINGS

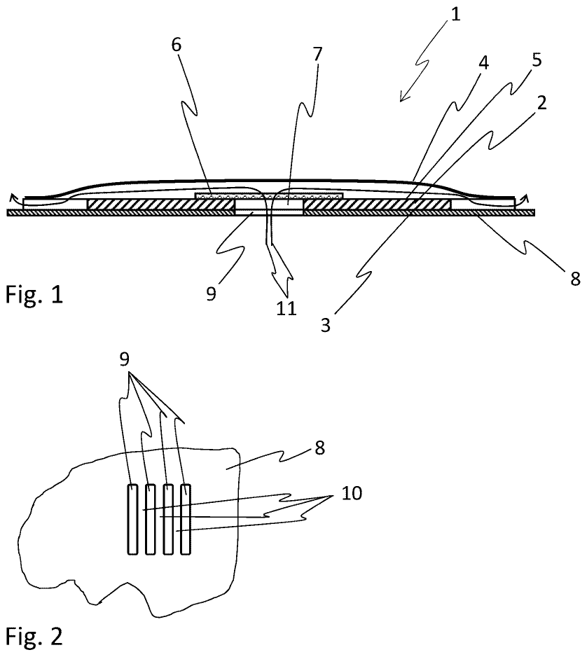

FIG. 1 shows a pressure equalization element 1 for adhesive mounting onto a housing, wherein the housing comprises a pressure equalization opening. The pressure equalization element 1 includes a first film 2. This first film 2 has a first surface 3, which is intended for adhesive mounting onto the surface of this housing. Furthermore, the pressure equalization element 1 comprises a second film 4, which is located on the second surface 5 of this first film 2, opposite the first surface 3. This second film 4 is connected to the first film 2 in sections on this second surface 5. Geometrically located between the first and second film is the membrane film 6, which is positioned on the second surface 5 of the first film 2. The first film 2 includes a pressure equalization cut-out 7, which is covered by the membrane film 6.

The pressure equalization element 1 is shown in its pre-installation state on the surface of the housing; therefore, it is mounted with the first film 2 and its first surface 3 on a carrier film 8. The carrier film 8 can be understood as a protective layer for an adhesive coating on this first surface 3. Furthermore, the carrier film 8 can be removed from this first surface 3 for installation. In practical terms, the carrier film 8 is peeled off from the first surface 3, thereby exposing the adhesive coating. When affixing—that is, during installation of the pressure equalization element onto the housing—the pressure equalization element is pressed on. This may temporarily alter the function of the membrane film 6, making an immediate functional test of the pressure equalization element after installation more difficult. In the depicted embodiment, the carrier film 8 includes a test cut-out 9, wherein the test cut-out 9 is formed and the carrier film 8 is arranged on the first surface in such a way that the test cut-out 9 and the pressure equalization cut-out 7 are positioned congruently with one another.

Through this configuration of the pressure equalization element 1 and the carrier film 8 on which it is mounted, a test air flow 11 can be generated through the membrane film 6 by way of an appropriate pressure differential, even when the carrier film 8 is still arranged on the pressure equalization element 1. In other words, this makes it possible to test the functionality of the pressure equalization element shortly before its installation and to prevent non-functional pressure equalization elements 1 from entering the production process in the first place.

FIG. 2 shows an embodiment of the disclosure in a view of the carrier film 8. In this embodiment, the carrier film 8 comprises a plurality of test cut-outs 9, which are separated from one another by carrier film webs 10. In this embodiment as well, the carrier film 8 is arranged in such a way that the test cut-outs 9 overlap with the pressure equalization cut-out (not visible in this view), and the carrier film webs at least partially cover this pressure equalization cut-out.

In other words, in series production of housings with pressure equalization elements, a roll of such pressure equalization elements is usually supplied, on which a plurality of pressure equalization elements are wound on a carrier film, comparable to a roll of labels wound on a liner. This roll with pressure equalization elements can be inserted into a dispensing machine that separates the pressure equalization elements so that a robotic gripper can pick them up individually. A manufacturing robot with this robotic gripper then installs the pressure equalization elements onto the housing with a pressure equalization opening.

Subsequently, the installed pressure equalization element can be covered by a second robotic gripper using a vacuum or pressure bell, and in particular subjected to negative pressure to test the pressure equalization element. This negative pressure generates a test air flow through the installed pressure equalization element; the test air flow passing through the pressure equalization element in its installed state is then measured. It has been shown that the affixing/pressing—that is, the installation—of the pressure equalization element compresses the interface, and this deformation can affect flow behavior for a considerable period. Thus, a pressure equalization element that has just been installed may exhibit different flow values than one that has been installed for a long time, especially for several hours. The flow values of a freshly installed pressure equalization element are lower than those of an uninstalled or long-installed element, as the membrane film, which is traversed by the pressure equalization flow, is essentially “compressed” and takes time to relax. If a correlation is assumed between the “compressed” membrane film and the desired iO flow values, a functional test can also be conducted in this compressed state. However, a disadvantage of this approach is that the precise threshold for flow is not measured, but only the test air flow of a compressed membrane film is captured. If the pressure equalization element is determined to be defective (niO status) during the test air flow measurement, elaborate rework is required.

By contrast, it is proposed to design the carrier film—on which the pressure equalization elements are wound—in such a way that the carrier film has at least one cut-out, referred to as a test cut-out, for each pressure equalization element. This test cut-out enables a functional test to be performed on each pressure equalization element before it is removed from the carrier film, which is necessary for installation. For this purpose, a pressure bell may cover the pressure equalization element from at least one side and seal against the carrier film, so that a test pressure (positive or negative) can be applied to the pressure equalization element within the pressure bell, thereby generating a pressure differential that produces a test air flow through the pressure equalization element. The test air flow can then pass through the opening in the carrier film. Since, in this procedure, the membrane film of the pressure equalization element—unlike in a carrier film without an appropriate cut-out—is not compressed, a realistic functional test of the pressure equalization element can be conducted.

In particular, with the proposed configuration of the carrier film, the cycle time during installation and functional testing of pressure equalization elements can be reduced. A defective pressure equalization element can be identified before it is installed. The risk of rework and loss of cycle time is thereby reduced. This also enables a functional test of an uncompressed pressure equalization element. The modeling of “flow values immediately after installation” can be omitted, thereby improving fault detection.

List of reference signs:

| | |
|---|---|
| 1 | Pressure equalization element |
| 2 | First film |
| 3 | First surface of 2 |
| 4 | Second film |
| 5 | Second surface of 2 |
| 6 | Membrane film |
| 7 | Pressure equalization cut-out in 2 |
| 8 | Carrier film |
| 9 | Test cut-out in 8 |
| 10 | Carrier film web |
| 11 | Test air flow |

1.-5. (canceled)

6. A pressure equalization element for adhesively mounting onto a surface of a housing or another object provided with a pressure equalization opening, wherein the pressure equalization element comprises:
a first film with a first surface for adhesively mounting on a surface of a housing;
a second film, which is at least partially connected to a second surface of the first film, opposite the first surface; and,
a membrane film, arranged geometrically between the first and the second film on the second surface of the first film;
wherein the first film has a pressure equalization cut-out covered by the membrane film;
wherein the pressure equalization element, before installation onto the surface of the housing, is mounted with the first surface of the first film on a carrier film, the carrier film being removable from this first surface for installation, and the carrier film comprising at least one test cut-out, the at least one test cut-out and the pressure equalization cut-out at least partially overlapping.

7. The pressure equalization element according to claim 6, wherein the carrier film comprises a plurality of test cut-outs, which are separated from each other by carrier film webs, at least one or a plurality of the test cut-outs at least partially or fully overlapping with the pressure equalization cut-out, and at least one of the carrier film webs at least partially covering the test cut-outs.

8. The pressure equalization element according to claim 6, wherein the carrier film comprises at least one test cut-out and the at least one test cut-out and the pressure equalization cut-out are arranged congruently with respect to each other.

9. A method for installing a pressure equalization element according to any claim 6, comprising the steps:
placing the pressure equalization element with carrier film into a test device;
applying a pressure differential between the side of the pressure equalization element on which the carrier film is located and the opposite side of the pressure equalization element, so that this pressure differential results in a test air flow through the pressure equalization element;
evaluating the pressure equalization element based on the test air flow;
removing the carrier film from the first surface of the first film; and,
installing the pressure equalization element on the surface of the housing.

10. The method for installing a pressure equalization element according to claim 9, wherein the test air flow is detected directly or indirectly for the purpose of evaluating the pressure equalization element, and the detected test air flow is compared with a target test air flow.
